(19) United States
(12) Patent Application Publication
(10) Pub. No.: US 2019/0203526 A1
(43) Pub. Date: Jul. 4, 2019

(54) CORNER PADS

(71) Applicant: Amesbury Group, Inc., Amesbury, MA (US)

(72) Inventors: Gary E. Tagtow, Sioux Falls, SD (US); Michael M. May, Stillwater, MN (US); Jordan Scott, Sioux Falls, SD (US); Gavin Clark, Beresford, SD (US)

(21) Appl. No.: 16/229,931

(22) Filed: Dec. 21, 2018

Related U.S. Application Data
(60) Provisional application No. 62/651,583, filed on Apr. 2, 2018.
(60) Provisional application No. 62/650,516, filed on Mar. 30, 2018.
(60) Provisional application No. 62/611,446, filed on Dec. 28, 2017.

(51) Int. Cl. E06B 7/23

(52) U.S. Cl. CPC E06B 7/23

(57) ABSTRACT

A corner pad includes a backer having a first side and a second side. The first side is configured to receive an adhesive. The corner pad also includes a plurality of wands extending from the second side. Each of the plurality of wands includes a first end and a second end and each of the plurality of wands is integral with the backer at the second end forming an interface. Each interface is substantially parallel to one another.

### CROSS-REFERENCE TO RELATED APPLICATIONS

This application claims priority to and the benefit of U.S. Provisional Patent Application No. 62/611,446, filed on Dec. 28, 2017; U.S. Provisional Patent Application No. 62/650,516, filed on Mar. 30, 2018; and U.S. Provisional Patent Application No. 62/651,583, filed on Apr. 2, 2018; under 35 U.S.C. § 119(e), the disclosures of which are hereby incorporated herein by reference in their entirety.

### BACKGROUND

Hinged swing entry doors that are designed for use in residential housing applications typically have an interface between the door and door frame that consists of a gap, also known as a reveal. The gaps are frequently filled with weatherseals (also called weatherstripping, weather strips, seals, etc.) of various designs that are often mounted to base structures that are pressed into “kerf slots” in the frame. The weatherseals are designed to maintain an effective barrier against unwanted external environmental conditions, especially the infiltration of air and water. The weatherseals help to separate the internal and external environments by preventing the passage of noise, dust, heat, and light from one side of the door unit to the other through the gap. Certain weatherseals also have application in sliding or hinged windows and sliding doors. For clarity, however, the technologies described herein will be made in the context of hinged doors.

Most residential houses have at least one swing entry door unit that has a frame, hinges, and a latching mechanism that holds the door in place against a seal in order to isolate the indoor environment from the outdoor environment by reducing air and water infiltration. The hinge, latch, and head represent one general sealing challenge to weatherseal designers while the sill poses another unique challenge. At the sill, when air pressure and water are applied to the exterior of the door unit, air and water may penetrate the door opening at the lower corners where the perimeter weatherseal meets the sill cap. As such, corner pads may be mounted to the door fame above the sill cap and enable the reduction or prevention of air and water infiltration in the lower corners. Some known corner pads are urethane foam pads, however, since urethane foam has a relatively open cell structure, water may penetrate the corner pad material.

### SUMMARY

In an aspect, the technology relates to a corner pad including: a backer including a first side and a second side, wherein the first side is configured to receive an adhesive; and a plurality of wands extending from the second side, wherein each of the plurality of wands includes a first end and a second end, wherein each of the plurality of wands is integral with the backer at the second end forming an interface, and wherein each interface is substantially parallel to one another.

In an example, a coating is disposed on at least a portion of each of the plurality of wands and the coating includes a coefficient of friction less than a coefficient of friction of at least one of the plurality of wands. In another example, the coating is disposed at the first end of each of the plurality of wands. In still another example, the backer includes at least one outer edge, and each interface is substantially parallel to the at least one outer edge. In yet another example, each of the plurality of wands are substantially orthogonal to the backer. In an example, each of the plurality of wands are substantially parallel to one another.

In another example, each of the plurality of wands are disposed at an angle relative to the backer. In still another example, each of the plurality of wands are substantially parallel to one another. In yet another example, a first wand of the plurality of wands is disposed at a first angle to the backer and a second wand of the plurality of wands is disposed at a second angle to the backer, and the first angle is greater than the second angle. In an example, the first end of each of the plurality of wands have a substantially equal height above the second side. In another example, the corner pad further includes the adhesive.

In still another example, the adhesive is a contact adhesive. In yet another example, the backer includes a backer width and the plurality of wands are arranged along a wand portion width, and wherein the wand portion width is at least about 50% of the backer width. In an example, the wand portion width is at least about two-thirds of the backer width. In another example, the backer is formed from a material that has a different durometer than a material that the plurality of wands is formed by.

In another aspect, the technology relates to a corner pad including: a backer; a plurality of fins extending from the backer, the plurality of fins defining a plurality of cavities defined within the corner pad, wherein upon a portion of a door sliding across the corner pad, at least a portion of the plurality of fins deflect at least partially into the corresponding cavity of the plurality of cavities such that the engagement of the corner pad with the door generates a seal that restricts air and water from penetrating therethrough.

In an example, one or more struts span at least two adjacent fins of the plurality of fins, and the one or more struts are disposed at an angle relative to the at least two adjacent fins. In another example, the strut is disposed at a location distal from a terminal end of each of the plurality of fins.

In another aspect, the technology relates to a method of manufacturing a corner pad including: delivering a first material to an extrusion die; substantially simultaneously delivering a second material to the extrusion die, wherein the first material has a different durometer than the second material; and coextruding the first material with the second material to form an extruded product, wherein the extruded product includes a backer formed by the first material and a plurality of wands extending from the backer formed by the second material, wherein each of the plurality of wands are integral with the backer forming an interface, and wherein each interface is substantially parallel to one another.

In an example, the method further includes: delivering a third material to the extrusion die substantially simultaneously with the first material and the second material; and coextruding the third material such that the extruded product further includes a coating disposed on at least a portion of each of the plurality of wands.

### BRIEF DESCRIPTION OF THE DRAWINGS

There are shown in the drawings, embodiments that are presently preferred, it being understood, however, that the technology is not limited to the precise arrangements and instrumentalities shown.

FIG. 1 is an end view of an exemplary corner pad.

FIGS. 2A-2C are perspective views of the corner pad shown in FIG. 1 in operation with a hinged door.

FIG. 3 is an end view of another corner pad.

FIG. 4 is an end view of another corner pad.

FIG. 5 is a flowchart illustrating an exemplary method of manufacturing a corner pad.

FIG. 6 is a perspective view of another corner pad.

FIG. 7 is a perspective view of another corner pad.

FIG. 8A is a perspective view of another corner pad.

FIG. 8B is a front view of the corner pad shown in FIG. 8A.

FIG. 8C is a cross-section view of the corner pad shown in FIG. 8B taken along line 8C.

FIG. 8D is a partial enlarged view of the corner pad shown in FIG. 8B.

FIG. 9A is a perspective view of another corner pad.

FIG. 9B is a front view of the corner pad shown in FIG. 9A.

FIG. 9C is an end view of the corner pad shown in FIG. 9A.

FIG. 10 is a perspective view of another corner pad.

### DETAILED DESCRIPTION

It is desirable that weatherseals, such as corner pads, have good performance in the following areas and be properly certified by AAMA, WDNA, NFRC, and other voluntary accreditation bodies:

(A) Recovery/Resistance to Compression Set: The weatherseal should recover to a condition near its original uncompressed state after being compressed for a period of time.

(B) Weatherable/UV Resistant: The weatherseal should maintain dimensional and performance attributes after exposure to weather and UV light conditions.

(C) Water Absorption/Wicking: The weatherseal should reduce air and water penetration through the door reveal. In cold climates, water absorption into the cell structure can cause problems when the water freezes and expands. The seal should allow air to pass freely through the seal matrix (not across the sealing surface), but should not allow water to penetrate the seal matrix for the risk of freezing.

(D) Compression Force: A weatherseal should provide the proper range of operating force, or CLD (Compression Load Deflection) while tolerating a range of forces from “slamming” of a door to the low operating force of a child or elderly person (so as to meet, e.g., ADA compliance). Too low a CLD will fail to prevent air and water penetration, while too high a CLD might prevent proper closing.

Various materials may be used to manufacture corner pads, for example, but not limited to, open cell urethane foam molded in polyethylene film, elastomer based materials such as ethylene propylene diene monomer (M-class) (EPDM), or closed cell foam such as thermoplastic elastomer (TPE), thermoplastic vulcanisate (TPV), as well as vinyl nitrile (PVC/NBR).

Generally, open cell foam provides excellent compression recovery and compression force because air is able to evacuate from the foam during compression and re-enter during expansion. However, the foam is not very resistant to UV-light conditions and the repetitive sliding of the door across its surface. Additionally, water and air can also penetrate the door opening through the open cell structure of the foam. A film or resin cover may be used to cover some or all of the exterior surfaces of the open cell foam.

On the other hand, closed cell foam provides excellent resistance to air and water infiltration. However, the foam offers higher than desirable compression force, because as the foam is compressed, air that is contained within the cells is forced through a network of microscopic interconnections between the cells in order for the foam to take on its compressed shape. In hinged door applications, there is generally inadequate time to allow the air to properly evacuate the cell structure when the door is closed, especially in thick corner pads. Like the open cell foam, a film or resin cover may be used to cover some or all of the exterior surfaces of the closed cell foam.

Elastomer, for example, EPDM and the like, provides excellent resistance to air and water infiltration, as well as, resistance to UV-light conditions and the repetitive sliding of the door across its surface. Additionally, the elastomer provides excellent compression recovery because of its elastomeric properties. However, the elastomer offers higher than desirable compression force, and thus, it is difficult to use the elastomer at the lower corner gaps of the door due to the varying thickness of the gap from construction tolerances. Providing a thinner elastomer corner pad may not properly seal a door with a larger gap, and providing a thicker elastomer corner pad may not allow for the door to properly close.

As such, and as described further below, various corner pad designs are provided that increase the performance thereof. These corner pad designs include a plurality of wands (also known as fins) extending from a backer. The wands are configured to contact the door as it closed and at least partially deflect upon the acting door force so as to create a seal between the door frame and the door to reduce or prevent air, water, dust, and/or debris from penetrating through the corner pad. Once the door force is removed from the corner pad, the wands are substantially resilient such that they at least partially return to their original position. The seal between the corner pad and the door is primarily formed by the deflection of the wands, however, the door force may also at least partially compress the wands as required or desired (e.g., to enhance the seal to the door). Since the seal is primarily formed by the deflection of the wands and not through compression of the corner pad, materials may be used for the corner pad that have high compressive strength while still enabling ADA compliance (e.g., not preventing a child or elderly person from closing the door). These materials can include substantially closed cell foam such as polypropylene, TPE, and TPV, and/or elastomer based materials such as EPDM.

In some examples, the wands may extend substantially parallel to a longitudinal axis of the backer. For example, the wands could extend substantially orthogonally to the backer or could extend at one or more angles relative to the backer. This structure enables for the wands to deflect and collapse with only some contact with adjacent wands so as to not increase the closing force of the door. A low friction coating may also cover at least a portion of the wands to further reduce the closing force required on the door. In these examples, the structure of the corner pads (e.g., parallel wands) enable for the corner pad to be manufactured via an extrusion or co-extrusion process. However, an injection molding process may also be used as required or desired.

In other examples, the wands may include one or more transverse members substantially perpendicular to the longitudinal axis. For example, the wands could extend between perimeter walls or one or more struts may extends between the wands. In other examples, a labyrinth seal (e.g., a pattern of wands and cavities) may be provided. This structure further restricts or prevents air, water, dust, and/or debris from penetrating along the longitudinal axis of the corner pad as required or desired. In these examples, the structure of the corner pads makes it difficult to extrude the shapes, but the corner pad manufacturing may be performed by insert molding processes.

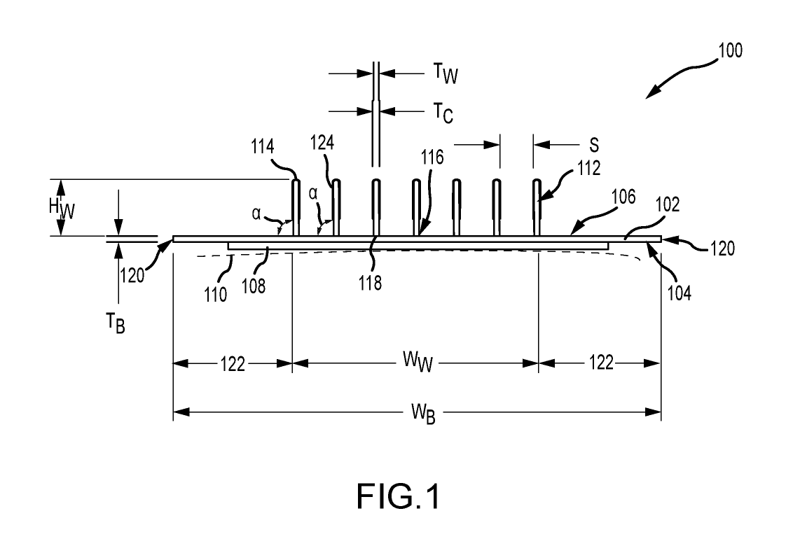

FIG. 1 is an end view of an exemplary corner pad 100. The corner pad 100 includes a backer 102 having a first side 104 and a second side 106. The first side 104 is configured to receive an adhesive 108 for securing the corner pad 100 to a door frame (not shown). In the example, the adhesive 108 may be a contact adhesive covered during shipping with a length of contact paper 110. In another example, the adhesive 108 may be field-applied to the first side 104. In yet another example, nails, screws, staples, or other mechanical fasteners may be used in place of, or in addition to, the adhesive 108, and typically passed through the backer 102. Regardless, the adhesives and/or other fasteners are used to secure the corner pad 100 to a door frame. As illustrated in FIG. 1, the backer 102 is depicted as substantially flat. In other examples, the backer 102 may be arched slightly (e.g., such that the first side 104 is somewhat concave), which may aid in adhering the corner pad 100 to the door frame. The backer 102 also has a thickness T_{B}.

The second side 106 of the backer 102 is opposite the first side 104. A plurality of wands 112 (also known as fins) extend from the second side 106. Each wand 112 includes a first end 114 and an opposite second end 116, and the wands 112 are spaced apart from each other by a distance S. The first end 114 has free movement and is cantilevered from the second side 106. The second end 116 is integral with the backer 102 and forms an elongate interface 118. In the depicted example, each of the plurality of interfaces 118 are parallel to each other, as are each of the plurality of wands 112. The backer 102 also includes two outer edges 120 defining a width W_{B}, to which the interfaces 118 and wands 112 are also substantially parallel to. Each of the wands 112 are disposed at an angle α that is substantially orthogonal to the backer 102. Each wand 112 includes a wand height H_{W} defined between the first end 114 and the second end 116, and in the example, each wand 112 has a substantially equal height H_{W}. In other examples, two or more wands 112 may have different heights H_{W} that may be as required or desired for a particular application. The spacing S between each wand 112 is substantially equal in the example. In other examples, the spacing S may be different between the wands 112 as required or desired.

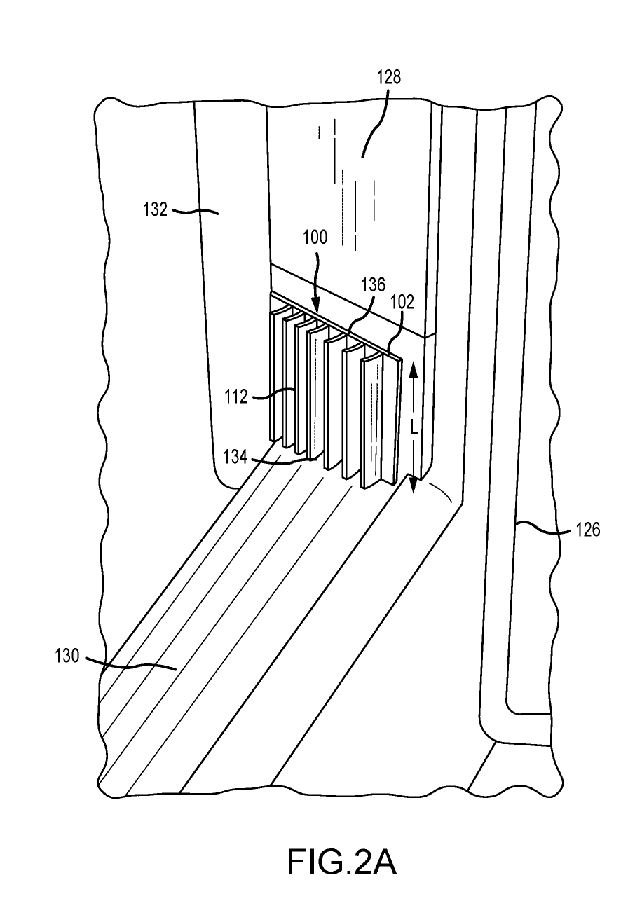

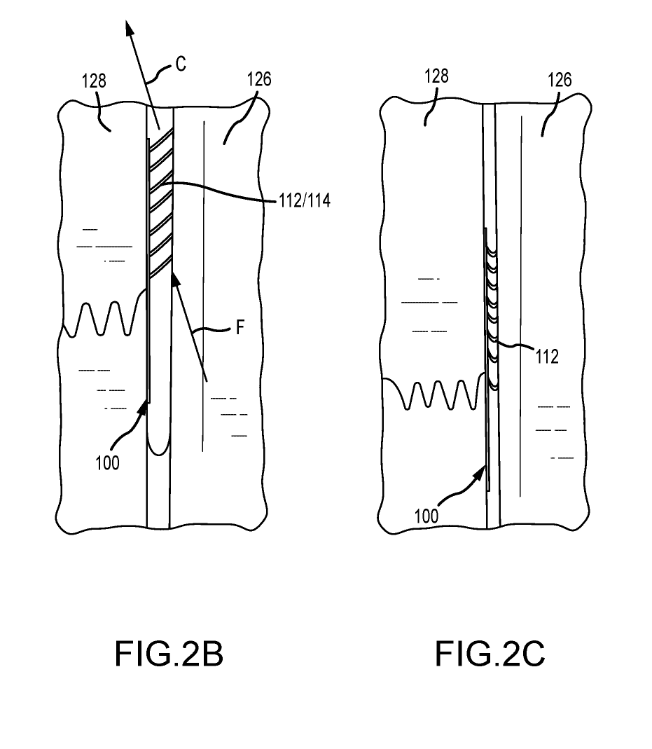

A length L (shown in FIG. 2A and extending into the page) of the corner pad 100 and both the backer 102 and the wands 112 extending therefrom may vary as required or desired for a particular application. In examples, the length of the backer 102 is generally the same as the length of the wands 112 and both may have a length of about two inches, although other lengths are contemplated. In other examples, the length of the wands 112 may be shorter or longer than the length of the backer 102. In the example, the wands 112 are disposed in a wand portion width W_{W} that extends along the backer width W_{B}. In examples, the wand portion width W_{W} is about 50% of the backer width W_{B}. In another example, the wand portion width W_{W} is about two-thirds of the backer width W_{B}. In other examples, the wand portion width W_{W} may be less than or greater than 50% of the backer width W_{B}. Additionally, the wand portion width W_{W} is centered on the backer width W_{B} so that two equally sized backer wings 122 are formed on either side of the wand portion width W_{W}, although this is not required. In other examples, the backer wings 122 on either side of the wand portion width W_{W} may have different sizes. The backer wings 122 may be field cut to any dimension as required or desired for a particular application.

The corner pad 100 also includes a low-friction coating 124 along at least a portion of the wand 112. In the example, the coating 124 at least partially covers the first end 114 of the wands 112 that is likely to contact portions of an adjacent wand 112 or a door panel. This coating reduces or eliminates frictional forces from the door engaging with the corner pad that tend to increase the closing force of the door. In other examples, the coating 124 may be applied to substantially the entire wand 112 as required or desired. In the example, each wand 112 has a wand thickness T_{W} that is less than the backer thickness T_{B}. In other examples, each wand thickness T_{W} may be approximately equal to, or greater than, the backer thickness T_{B}. The coating 124 covering the wands 112 may enlarge the first end 114 of the wand 112 to a cover thickness T_{C} that is greater than the backer thickness T_{B}. In other examples, each cover thickness T_{C} may be approximately equal to, or less than, the backer thickness T_{B}.

FIGS. 2A-2C are perspective views of the corner pad 100 in operation with a hinged door 126. Referring first to FIG. 2A, the corner pad 100 may have a length L of about two inches and can be adhered to a bottom of a door jamb 128 and adjacent to a sill 130. The corner pad 100 may be used in conjunction with a linear weatherseal 132 that extends along the door jamb 128. The corner pad 100 is adhered to the door jamb 128 such that the backer 102 is positioned against the door jamb 128 and the wands 112 extend substantially parallel to the height of the door 126. Accordingly and as illustrated in FIG. 2A, when the door 126 is opened, the wands 112 extends substantially orthogonal to the door jamb 128 and into the door opening. The corner pad 100 includes a first longitudinal end 134 and a second longitudinal end 136 that defines the length L. When the corner pad 100 is adhered to the door jamb 128, the ends 134, 136 are positioned proximate to the sill 130. In some examples, one or both of the ends 134, 136 may include one or more notches (not shown) cut therein and substantially parallel to the wands 112. These notches are sized and shaped so that the ends 134, 136 may form at least partially around the sill 130 as required or desired.

In operation, since the wands 112 are not supported along their longitudinal length or at the ends 134, 136 of the corner pad 100, other than by their own material stiffness, the wands 112 are able to collapse when acted upon by a force from the closing door 126. Referring now to FIG. 2B, as the door 126 closes it induces a force F proximate the first end 114 of the wands 112 such that the wands 112 will collapse in the direction C. In the example, the direction of the force F and the direction of the collapse C are substantially parallel to one another. FIG. 2C illustrates the door 126 in a completely closed position such that the wands 112 are completely collapsed. It should be appreciated, however, that the wands 112 do not need to fully collapse for the corner pad 100 to provide a seal between the door 126 and the door jamb 128.

It has been determined that the spacing distance S (shown in FIG. 1) of the wands 112 that allows the wands 112 to collapse C with only some contact with an adjacent wand 112 is desirable. Such limited contact is sufficient for the corner pad 100 to form a proper seal while not increasing significantly the closing force of the door 126. In examples, the spacing S is about 50% of the wand height H_{W} (shown in FIG. 1) though other configurations are contemplated. In other examples, the spacing S may be greater than or less than the wand height H_{W} as required or desired. Once the force F of the door 126 is removed from the corner pad 100, the resilience of the wands 112 allow them to return towards to their original orthogonal position relative to the backer 102. Upon return, the wands 112 need not necessarily return to the depicted position in FIG. 1, where all of the wands 112 are orthogonal to the backer 102 along the entire wand height H_{W}. The wands 112 may collapse C in either direction that is substantially orthogonal to the interfaces 118 (shown in FIG. 1) so that the corner pad 100 may be used for hinged doors that swing in any direction.

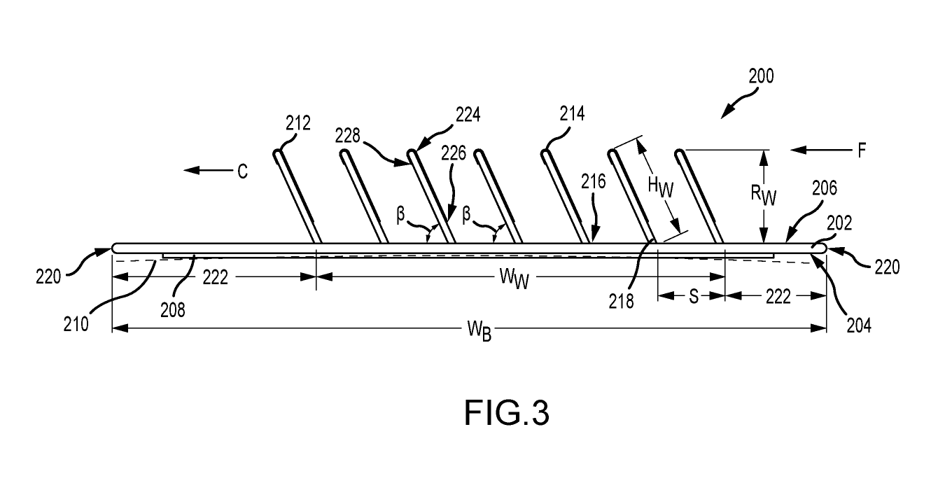

FIG. 3 is an end view of another corner pad 200. Similar to the example described above, the corner pad 200 includes a backer 202 having a first side 204 and a second side 206. The first side 204 is configured to receive an adhesive 208 for securing the corner pad 200 to a door frame (not shown). In the example, the adhesive 208 may be a contact adhesive covered during shipping with a length of contact paper 210. In another example, the adhesive 208 may be field-applied to the first side 204. In yet another example, mechanical fasteners may be used. As illustrated in FIG. 3, the backer 202 is depicted as substantially flat. In other examples, the backer 202 may be arched slightly (e.g., such that the first side 204 is somewhat concave), which may aid in adhering the corner pad 200 to the door frame. The second side 206 of the backer 202 is opposite the first side 204. A plurality of wands 212 (also known as fins) extend from the second side 206. Each wand 212 includes a first end 214 and an opposite second end 216, and the wands 212 are spaced apart from each other by a distance S. The first end 214 has free movement and is cantilevered from the second side 206. The second end 216 is integral with the backer 202 and forms an elongate interface 218. Each of the plurality of interfaces 218 are parallel to each other, as are each of the plurality of wands 212. The backer 202 also includes two outer edges 220 defining a width W_{B}, to which the interfaces 218 and wands 212 are also substantially parallel to.

In this example, however, each of the wands 212 are disposed at an angle β to the backer 202. In examples, the angle β may be about 45° to about 85°, about 55° to about 80°, or about 60° to about 75°. In the depicted example, the angle β is about 65°. Each wand 212 includes a wand height H_{W} defined between the first end 214 and the second end 216, and in the example, each wand 212 has a substantially equal height H_{W}. In the example, since the wands 212 are oriented at the angle β, a reach R_{W} of the first end 214 from the backer 202 is less than the height H_{W} of the wand 212. In other examples, two or more wands 212 may have different heights H_{W} or angles β that may be as required or desired for a particular application. The spacing S between each wand 212 is substantially equal in the example. In other examples, the spacing S may be different between the wands 212 as required or desired, for example, if different heights H_{W} or angles β are used.

A length L (shown in FIG. 2A and extending into the page) of the corner pad 200 and both the backer 202 and the wands 212 extending therefrom may vary as required or desired for a particular application. In examples, the length of the backer 202 is generally the same as the length of the wands 212 and both may have a length of about two inches, although other lengths are contemplated. In other examples, the length of the wands 212 may be shorter or longer than the length of the backer 202. In the example, the wands 212 are disposed in a wand portion width W_{W} that extends along the backer width W_{B}. In examples, the wand portion width W_{W} is about 50% of the backer width W_{B}. In another example, the wand portion width W_{W} is about two-thirds of the backer width W_{B}. In other examples, the wand portion width W_{W} may be less than or greater than 50% of the backer width W_{B}. Additionally, the wand portion width W_{W} is depicted off-center on the backer width W_{B} so that two differently sized backer wings 222 are formed on either side of the wand portion width W_{W}, although this is not required. In other examples, the backer wings 222 on either side of the wand portion width W_{W} may have approximately equal sizes. The backer wings 222 may be field cut to any dimension as required or desired for a particular application.

The corner pad 200 also includes a low-friction coating 224 along at least a portion of the wand 212. In the example, the coating 224 at least partially covers the first end 214 of the wands 212 that is likely to contact portions of an adjacent wand 212 or a door panel. The coating 224 extends from a first terminus 226 to a second terminus 228 located higher on the wand 212 from the backer 202 than the first terminus 226. By offsetting the coating terminuses 226, 228 on the wand 212, the side of the wand 212 that is more likely to contact the door is formed with more coating than the side that is more likely to contact an adjacent wand 212. In other examples, the coating 224 may be applied to substantially the entire wand 212 as required or desired.

In operation, and similar to the corner pad described in FIGS. 2A-2C above, the corner pad 200 may have a longitudinal length of about two inches and can be adhered to a bottom of a door jamb. Since the wands 212 are not supported along their longitudinal length or at the ends of the corner pad 200, other than by their own material stiffness, the wands 212 are able to collapse when acted upon by a force from the closing door. As the door closes it induces a force F proximate the first end 214 of the wands 212 such that the wands 212 will collapse C. In the example, the direction of the door force F and the direction of the collapse C are substantially parallel to one another and are oriented such that the angle β collapses on itself. It should be appreciated, however, that the wands 212 do not need to fully collapse for the corner pad 200 to provide a seal between the door and the door jamb.

It has been determined that the spacing distance S of the wands 212 that allows the wands 212 to collapse C with only some contact with an adjacent wand 212 is desirable. Such limited contact is sufficient for the corner pad 200 to form a proper seal while not increasing significantly the closing force of the door. In examples, the spacing S is about 50% of the wand height H_{W} though other configurations are contemplated. In other examples, the spacing S may be greater than or less than the wand height H_{W} as required or desired. Once the force F of the door is removed from the corner pad 200, the resilience of the wands 212 allows them to return towards to their original angled position relative to the backer 202. Upon return, the wands 212 need not necessarily return to the depicted position in FIG. 3, where all of the wands 212 are angled relative to the backer 202 along the entire wand height H_{W}. Some permanent deflection or deformation of each wand 212 after collapse C is acceptable.

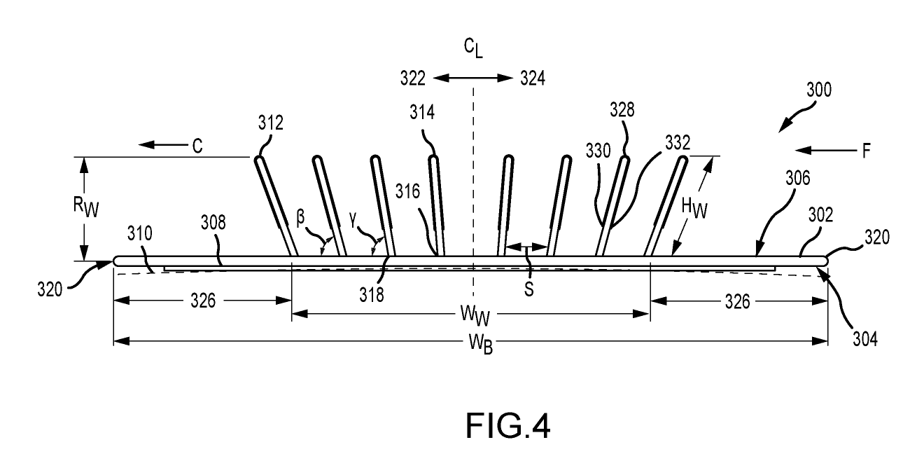

FIG. 4 is an end view of another corner pad 300. Similar to the examples described above, the corner pad 300 includes a backer 302 having a first side 304 and a second side 306. The first side 304 is configured to receive an adhesive 308 for securing the corner pad 300 to a door frame (not shown). In the example, the adhesive 308 may be a contact adhesive covered during shipping with a length of contact paper 310. In another example, the adhesive 308 may be field-applied to the first side 304. In yet another example, mechanical fasteners may be used. As illustrated in FIG. 4, the backer 302 is depicted as substantially flat. In other examples, the backer 302 may be arched slightly (e.g., such that the first side 304 is somewhat concave), which may aid in adhering the corner pad 300 to the door frame. The second side 306 of the backer 302 is opposite the first side 304. A plurality of wands 312 (also known as fins) extend from the second side 306. Each wand 312 includes a first end 314 and an opposite second end 316, and the wands 312 are spaced apart from each other by a distance S. The first end 314 has free movement and is cantilevered from the second side 306. The second end 316 is integral with the backer 302 and forms an elongate interface 318. Each of the plurality of interfaces 318 are parallel to each other, as are each of the plurality of wands 312. The backer 302 also includes two outer edges 320 defining a width W_{B}, to which the interfaces 318 and wands 312 are also substantially parallel to.

In this example, each of the wands 312 are disposed at an angle to the backer 302, however, the angles may be different between adjacent wands 312. As such, different angles θ and y are depicted in FIG. 4, although each wand 312 may be disposed at a different angle from an adjacent wand. In examples, the angles at which the wands 312 are oriented relative to the backer 302 may be between about 90° to about 45°. As such, not all of the wands 312 are parallel to each other. Also, each wand 312 depicted on a first side 322 of a centerline CL of the backer 302 are disposed in a first general direction (e.g., pointing toward the left), while each wand 312 depicted on a second side 324 of a centerline CL of the backer 302 are disposed in a second general direction (e.g., pointing toward the right). By pointing in generally opposite directions, the corner pad 300 may be field installed so as to engage with a door swinging in any direction. In the example, the wands 312 are substantially symmetrically about the centerline CL, however, in other examples, this need not be the case.

Each wand 312 includes a wand height H_{W} defined between the first end 314 and the second end 316. Additionally, since the wands 312 are oriented at angles, a reach R_{W} of the first end 214 from the backer 202 is defined. In the example, the reach R_{W} of each wand 312 is substantially equal, but the height H_{W} of the wands 312 may be different. In other examples, the height H_{W} of each wand 312 may be approximately equal as required or desired for a particular application. The spacing S between each wand 312 is varies based on the angles of each wand 312 in the example. In other examples, the spacing S may be approximately equal between the wands 312 as required or desired, for example, if similar heights H_{W} or angles are used.

A length L (shown in FIG. 2A and extending into the page) of the corner pad 300 and both the backer 302 and the wands 312 extending therefrom may vary as required or desired for a particular application. In examples, the length of the backer 302 is generally the same as the length of the wands 312 and both may have a length of about two inches, although other lengths are contemplated. In other examples, the length of the wands 312 may be shorter or longer than the length of the backer 302. In the example, the wands 312 are disposed in a wand portion width W_{W} that extends along the backer width W_{B}. In examples, the wand portion width W_{W} is about 50% of the backer width W_{B}. In another example, the wand portion width W_{W} is about two-thirds of the backer width W_{B}. In other examples, the wand portion width W_{W} may be less than or greater than 50% of the backer width W_{B}. Additionally, the wand portion width W_{W} is centered on the backer width W_{B} so that two equally sized backer wings 326 are formed on either side of the wand portion width W_{W}, although this is not required. In other examples, the backer wings 326 on either side of the wand portion width W_{W} may have different sizes. The backer wings 326 may be field cut to any dimension as required or desired for a particular application.

The corner pad 300 also includes a low-friction coating 328 along at least a portion of the wand 312. In the example, the coating 328 at least partially covers the first end 314 of the wands 312 that is likely to contact portions of an adjacent wand 312 or a door panel. The coating 328 extends from a first terminus 330 to a second terminus 332 both located at approximately the same location on the wand 312 from the backer 302. By extending the coating 328 approximately the same distance on either side of each wand 312, the wands 312 have similar performance when bending to the first side 322 and to the second side 324. In other examples, the coating 224 may be applied to substantially the entire wand 212 as required or desired.

In operation, and similar to the corner pad described in FIGS. 2A-2C above, the corner pad 300 may have a longitudinal length of about two inches and can be adhered to a bottom of a door jamb. Since the wands 312 are not supported along their longitudinal length or at the ends of the corner pad 300, other than by their own material stiffness, the wands 312 are able to collapse when acted upon by a force from the closing door. As the door closes it induces a force F proximate the first end 314 of the wands 312 such that the wands 312 will collapse C. In the example, the direction of the door force F and the direction of the collapse C are substantially parallel to one another. It should be appreciated, however, that the wands 312 do not need to fully collapse for the corner pad 300 to provide a seal between the door and the door jamb.

It has been determined that the spacing distance S of the wands 312 that allows the wands 312 to collapse C with only some contact with an adjacent wand 312 is desirable. Such limited contact is sufficient for the corner pad 300 to form a proper seal while not increasing significantly the closing force of the door. In examples, the spacing S is about 50% of the wand height H_{W} though other configurations are contemplated. In other examples, the spacing S may be greater than or less than the wand height H_{W} as required or desired. Once the force F of the door is removed from the corner pad 300, the resilience of the wands 312 allows them to return towards to their original angled position relative to the backer 302. Upon return, the wands 312 need not necessarily return to the depicted position in FIG. 4, where all of the wands 312 are angled relative to the backer 302 along the entire wand height H_{W}. Some permanent deflection or deformation of each wand 312 after collapse C is acceptable.

The corner pads described above in FIGS. 1-4 may be manufactured in accordance with processes now known or developed in the future. For example, the corner pad profiles may be cut from extruded, cooled pieces of foam material utilizing laser cutting processes, hot wire cutting processes, or other processes. Desirable manufacturing processes such as extrusion, sequential extrusion, and/or co-extrusion are known in the art. The corner pad may be manufactured using rigid or elastomeric materials that are extrudable/coextrudable, such as polypropylene, thermoplastic vulcanisate, and thermoplastic elastomer. Since coextrusion may be utilized, a more rigid material may be utilized for the backer, with a less rigid material utilized for the wands. Coatings may be low friction materials that are coextrudable with the wand materials, such as polypropylene or polyethylene. In one example, the backer, the wands, and the coatings are all formed from polymer material with each having a different durometer so as to enable the component to function as described herein. In another example, the backer, the wands, and/or the coatings may be all formed from a single material so that a single extrusion or a sequential/serial extrusion process can be used. It is appreciated that while the corner pads described above may be manufactured by an extrusion process, the corner pads may alternatively or additionally be molded as required or desired.

In the figures above, exemplary examples are depicted having particular dimensions. These dimensions are but examples and corner pads having other dimensions are contemplated. As such, the backer and wands may have differing lengths, widths, and/or heights, as required or desired for a particular application. As noted above, the backer and wands may be manufactured from the same material. The backer may be extruded at a greater thickness than the wands so as to provide more rigidity to the corner pad, or may be a similar thickness (or even thinner, in certain applications). In another example, the rigidity of the components may be based on the durometer of the extruded material. A wand may have a reach of about 0.25 inches to about 0.375 inches, although any reach is contemplated as required or desired to seal the gap in the door. Additionally, adhesives may be applied to different areas of the backers, and coatings may be applied to different areas of the wands, as described herein.

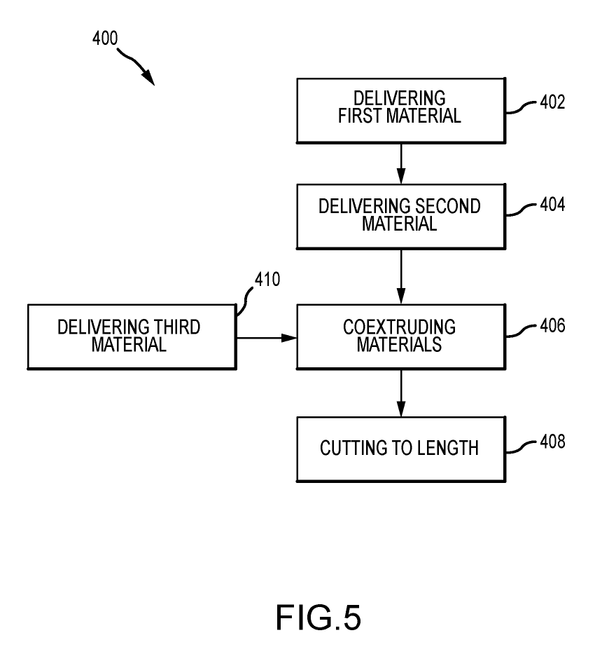

FIG. 5 is a flowchart illustrating an exemplary method 400 of manufacturing a corner pad. As described above the corner pad may be manufactured by an extrusion process, however, a molding process may be used as required or desired. During the extrusion process, the method 400 includes delivering a first material to an extrusion die (operation 402). Substantially simultaneously with operation 402, a second material is delivered to the extrusion die (operation 404). The first material may have a different durometer than the second material. The first material is coextruded with the second material to form an extruded product (operation 406). The extruded product includes a backer formed by the first material and a plurality of wands extending from the backer formed by the second material. The extruded product can then be cut to length as required or desired (operation 408). In some examples, the method 400 may further include delivering a third material to the extrusion die substantially simultaneously with the first material and the second material (operation 410). The third material is then coextruded in operation 406 and the extruded product further includes a coating disposed on at least a portion of each of the plurality of wands. In yet other examples, the extrusion process may include extruding the backer either prior to or sequentially before extruding the wands and securing the wands to the backer. In still other examples, the backer and the wands may be extruded together and formed from a single type of material.

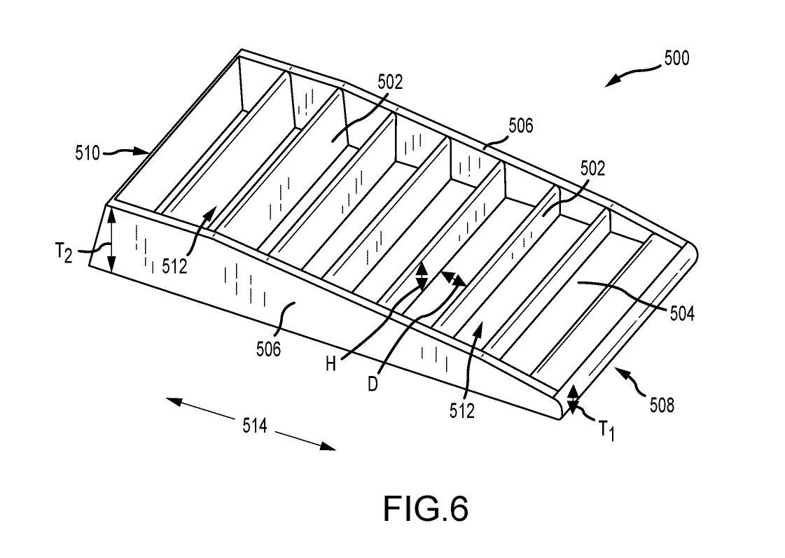

FIG. 6 is a perspective view of another corner pad 500. The corner pad 500 includes a plurality of fins 502 (also known as wands) that are spaced apart a distance D and joined by a continuous backer 504. In this example, the fins 502 extend substantially orthogonally from the backer 504 and between perimeter walls 506. In some examples, the fins 502 are connected to the perimeter wall 506, while in other examples, the fins 502 may only be partially connected or not connected at all to the perimeter wall 506 so as to increase the deflection of the fins 502 during operation. In still other examples, one or more of the perimeter walls 506 may not be include on the corner pad 500, similar to the examples described above. In yet other examples, the fins 502 may be disposed at an angle relative to the backer 504. The corner pad 500 is substantially wedge shaped with a first end 508 having a thickness T₁ that is less than a thickness T₂ at a second end 510. As such, a height H of the fins 502 progressively increases from the fins 502 positioned proximate the first end 508 towards the fins 502 positioned proximate the second end 510.

The fins 502, the backer 504, and the perimeter walls 506 define a plurality of cavities 512. The cavities 512 provide a void within the corner pad 500 that enable the fins 502 to be deflected by the door as it is opened and closed. In operation, corner pad 500 is mounted in the door frame such that the cavities 512 are positioned on a front side of the corner pad 500 with the backer 504 defining the rear side. The first end 508 is positioned towards the swing side of the door frame (e.g., the side to which the door swings to open) and the fins 502 are oriented substantially vertically within the door frame. This positions the fins 502 substantially perpendicular to a swing direction 514 of the door. When the door opens and closes the fins 502 deflect into the corresponding cavity 512 and form a seal between the door frame and the door such that air, water, dust, and/or debris is reduced or prevented from penetrating through the seal. The use of the perimeter walls 506 that are transverse to the fins 502 facilitate reducing or preventing of air, water, dust, and/or debris from penetrating the corner pad 500 in a direction that is substantially parallel to the fins 502. Additionally or alternatively, the perimeter walls 506 facilitate reducing or preventing the fins 502 from contacting one another during collapse. This corner pad 500 configuration may generate up to and including a 50% improvement in air and water infiltration and durability compared to other know corner pad designs.

Additionally, as the fins 502 deflect, the elastomer material is resilient such that the fins 502 maintain contact with the door so as to provide a seal with the door. The corner pad 500 is wedge shaped so that doors having a larger gap or reveal may engage with the corner pad 500 more towards the second end 510, while doors having a smaller gap or reveal may engage more towards the first end 508. The fins 502 may deflect in either direction along the swing direction 514 so as to accommodate the door engaging more towards the second end 510 of the corner pad 500.

In the example, the height H of each fin 502 is different than the adjacent fins, but the thickness of the fins 502 are substantially equal. In other examples, one or more fins 502 may have a height H that is the same or similar to one or more of the adjacent fins 502, and/or one or more of the fins 502 may have different thicknesses. Additionally, in the example, the distance D between each fin 502 is substantially equal. In other examples, one or more distances D may be different from one another. For example, the distance D may correspond to the height H of the longest adjacent fin 502 so that the fins 502 may deflect into either adjacent cavity 512 without contacting the adjacent fins 502.

On the rear side of the corner pad 500, the backer 504 may include an adhesive layer (not shown) so that the corner pad 500 may be secured to the door frame. In some examples, the adhesive layer is an acrylic transfer tape with a paper liner or equivalent. In other examples, the backer 504 may be mechanically fastened to the door frame by a nail, a staple, or the like. By using a mechanical fastener, the manufacturing costs of the corner pad 500 can be reduced. In yet other examples, the backer 504 may be arched slightly, which may aid in adhering the corner pad 500 to the door frame.

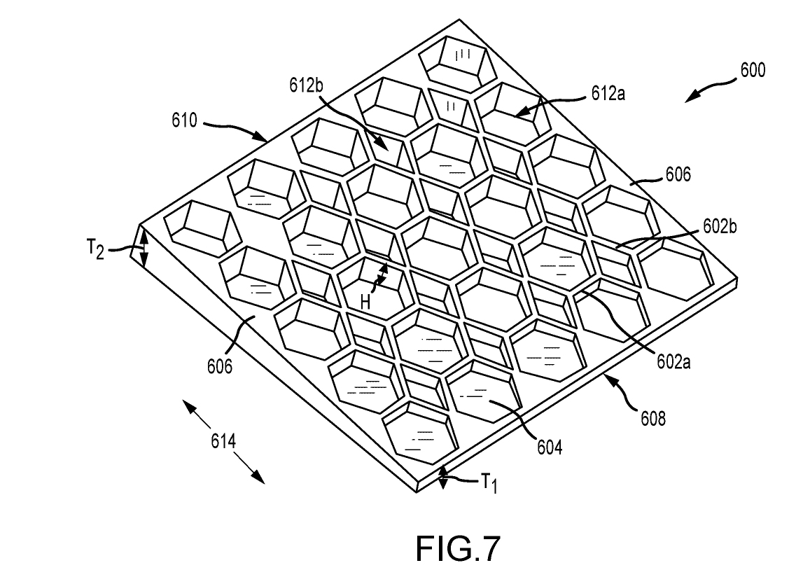

FIG. 7 is a perspective view of another corner pad 600. In this example, the corner pad 600 includes a plurality of fins 602 (also known as wands) shaped in a honeycomb-type pattern and joined by a continuous backer 604. In the example, the fins 602 extend substantially orthogonally from the backer 604 and between perimeter walls 606. In some examples, the fins 602 are connected to the perimeter walls 606 and/or to each other, while in other examples, the fins 602 may only be partially connected or not connected at all to the perimeter walls 606 and/or each other so as to increase the deflection of the fins 602 during operation. In still other examples, one or more of the perimeter walls 606 may not be include on the corner pad 600, similar to the examples described above. In yet other examples, the fins 602 may be disposed at an angle relative to the backer 604. The corner pad 600 is substantially wedge shaped with a first end 608 having a thinner thickness T₁ than a thickness T₂ at a second end 610. As such, a height H of the fins 602 extending from the backer 604 increases from the fins 602 positioned proximate the first end 608 towards the fins 602 positioned proximate the second end 610 forming a tapered configuration.

The fins 602, the backer 604, and the perimeter walls 606 define a plurality of cavities 612. The cavities 612 provide a void within the corner pad 600 that enable the fins 602 to be deflected by the door as it is opened and closed. In this example, the cavities are substantially hexagonal 612a and diamond 612b in shape, although other shapes are also contemplated herein. The hexagonal cavities 612a are formed by two opposing fins 602a that are oriented substantially perpendicular to a door swing direction 614 and two pairs of opposing fins 602b that are angled in relation to the door swing direction 614. The diamond cavities 612b are formed by the two pairs of opposing fins 602b. In the example, each fin 602 has a substantially equal thickness; however, in alternative examples, one or more of the fins 602 may have a different thickness.

Similar to the operation of the corner pad described above in FIG. 6. When the door opens and closes the fins 602 deflect into the corresponding cavity 612 and form a seal between the door frame and the door such that air, water, dust, and/or debris is reduced or prevented from penetrating through the seal. By angling the fins 602b in a direction other than parallel to the door swing direction 614, the fins 602b are deflectable upon contact by the door, rather than solely compressing, and reduce the compressive force of the elastomer material. Additionally, use of the perimeter walls 606 facilitate reducing or preventing of air, water, dust, and/or debris from penetrating the corner pad 600 in a direction that is substantially orthogonal to the door swing direction 614. This corner pad 600 configuration may generate up to and including a 50% improvement in air and water infiltration and durability compared to other known corner pad designs. In other examples, the fins 602 may be formed in any other geometric pattern as required or desired, such as only in a hexagonal pattern, a diamond pattern, a triangular pattern, or any other polygonal shaped pattern either uniform in shape or having two or more shapes defined therein. In further examples, the connections between the fins 602 may include a slit extending at least a portion of the height H of the fins 602 to facilitate a more easy deflection into the cavities 612.

The corner pad 600 is wedge shaped so that doors having a larger gap or reveal may engage with the corner pad 600 more towards the second end 610, while doors having a smaller gap or reveal may engage more towards the first end 608. The fins 602a may deflect in either direction along the swing direction 614 so as to accommodate the door engaging more towards the second end 610 of the corner pad 600. Additionally, the fins 602b may deflect into either adjacent cavity 612.

Also, on the rear side of the corner pad 600, the backer 604 may include an adhesive layer (not shown) so that the corner pad 600 may be secured to the door frame. In some examples, the adhesive layer is an acrylic transfer tape with a paper liner or equivalent. In other examples, the backer 604 may be mechanically fastened to the door frame by a nail, a staple, or the like. In yet other examples, the backer 604 may be arched slightly, which may aid in adhering the corner pad 600 to the door frame.

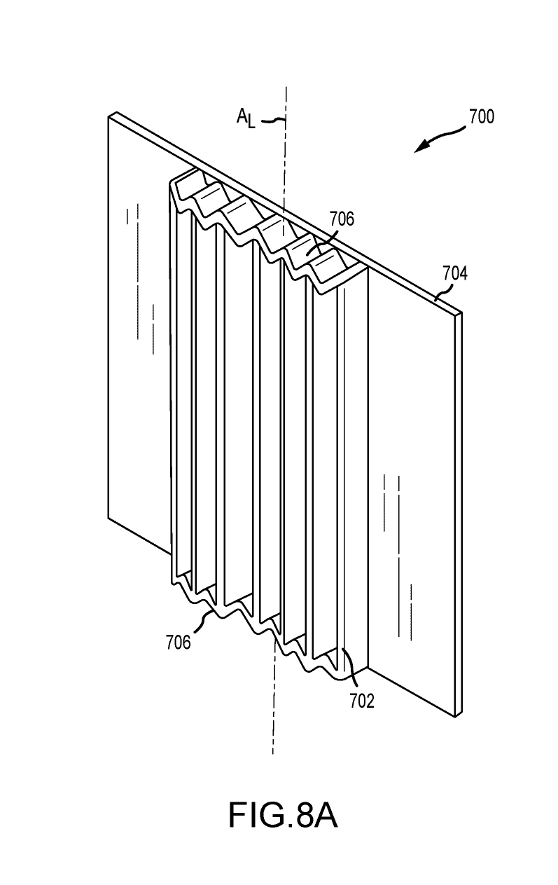

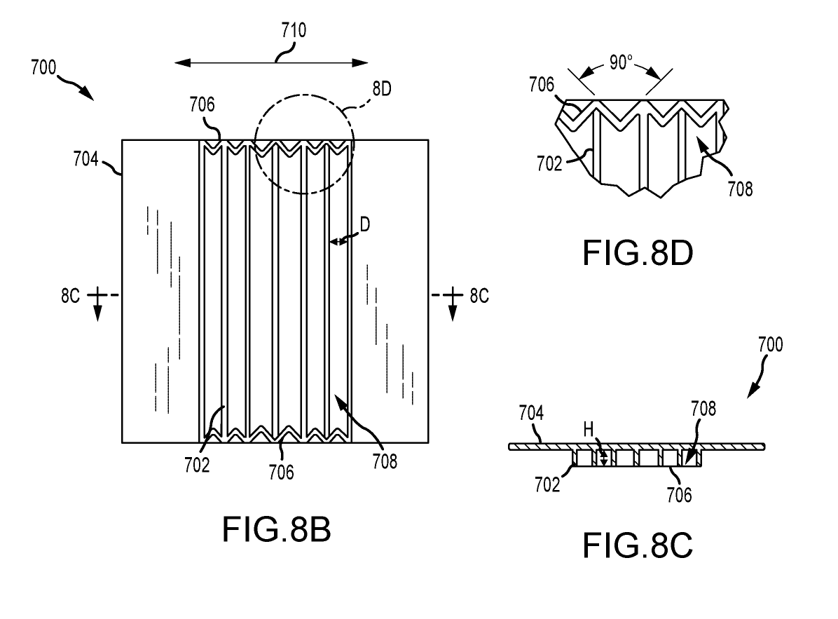

FIG. 8A is a perspective view of another corner pad 700. FIG. 8B is a front view of the corner pad 700. FIG. 8C is a cross-section view of the corner pad 700 taken along line 8C. FIG. 8D is a partial enlarged view of the corner pad 700. Referring concurrently to FIGS. 8A-8D, the corner pad 700 includes a plurality of fins 702 (also known as wands) that are spaced apart a distance D and joined by a continuous backer 704. The fins 702 extend substantially orthogonally from the backer 704 and between perimeter walls 706. In other examples, the fins 702 may be angled relative to the backer 704. In this example, the perimeter wall 706 is accordion shaped with each wall portion positioned approximately 90° relative to one another as shown in FIG. 8D. This enables for the portion of the fins 702 adjacent to the perimeter walls 706 to deflect a greater amount and form a tighter seal during operation. The fins 702 may extend from any interior corner of the perimeter wall 706, for example, the interior corner that forms the outer end of the corner pad 700 as illustrated in FIG. 8D. In other examples, the perimeter wall 706 can be oriented at any other angle, for example, angles between 45° and 90° and/or have the fins 702 extend from other locations on the perimeter wall 706.

In some examples, the fins 702 are connected to the perimeter wall 706, while in other examples, the fins 702 may only be partially connected or not connected at all to the perimeter wall 706 so as to further increase the deflection of the fins 702. In still other examples, one or more of the perimeter walls 706 may not be include on the corner pad 700, similar to the examples described above. Unlike the wedge shaped corner pads described above that requires specific orientation when secured within the door frame, the corner pad 700 in this example is symmetrical about its longitudinal axis A_{L}, which corresponds to the fin direction and as shown in FIG. 8A. In the example, each fin 702 and the perimeter walls 706 have a substantially similar height H (shown in FIG. 8C). This enables the corner pad 700 to be easily installed on the door frame when compared to the wedge shaped corner pads and have the same performance no matter which direction the door swings. Additionally, the corner pad 700 may be installed with either end (e.g., the perimeter wall 706) facing upward. In other examples, one or more fins 702 may have a different height H than another fin 702. In another example, the perimeter walls 706 may have a different height H than one or more fins 702. In yet another example, the perimeter wall 706 height H may vary or be shaped (e.g., curved or S-shaped) and each fin 702 height H corresponds to the position along the perimeter wall 706.

The fins 702, the backer 704, and the perimeter walls 706 define a plurality of cavities 708. The cavities 708 provide a void within the corner pad 700 that enable the fins 702 to be deflected by the door as it is opened and closed. In operation, corner pad 700 is mounted in the door frame such that the cavities 708 are positioned on a front side of the corner pad 700 with the backer 704 defining the rear side. The fins 702 are oriented substantially vertically within the door frame. This positions the fins 702 substantially perpendicular to a swing direction 710 of the door. When the door opens and closes the fins 702 deflect into the corresponding cavity 712 and form a seal between the door frame and the door such that air, water, dust, and/or debris is reduced or prevented from penetrating through the seal. The use of the perimeter walls 706 that are transverse to the fins 702 facilitate reducing or preventing of air, water, dust, and/or debris from penetrating the corner pad 700 in a direction that is substantially parallel to the fins 702. Additionally or alternatively, the perimeter walls 706 facilitate reducing or preventing the fins 702 from contacting one another during collapse.

In the example, the distance D between each fin 702 enables the deflection of the fins 702 without contacting one another. In other examples, the fins 702 may deflect and at least partially contact one another without significant stacking or overlap between adjacent fins 702. In some examples, the distance D between each fin 702 may be substantially equal in the corner pad 700, while in other examples the distance D between each fin 702 may be different.

On the rear side of the corner pad 700, the backer 704 may include an adhesive layer (not shown) so that the corner pad 700 may be secured to the door frame. In some examples, the adhesive layer is an acrylic transfer tape with a paper liner or equivalent. In other examples, the backer 704 may be mechanically fastened to the door frame by a nail, a staple, or the like. In yet other examples, the backer 704 may be arched slightly, which may aid in adhering the corner pad 700 to the door frame.

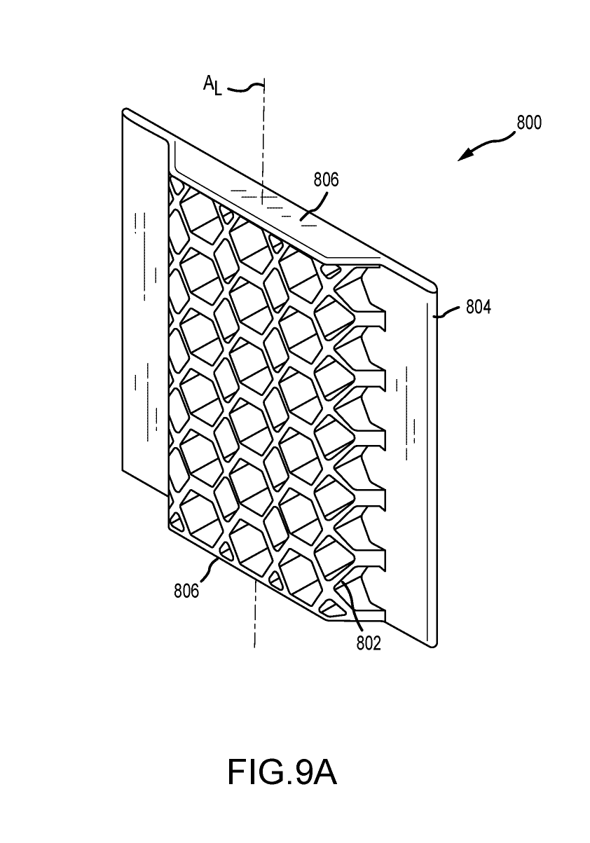

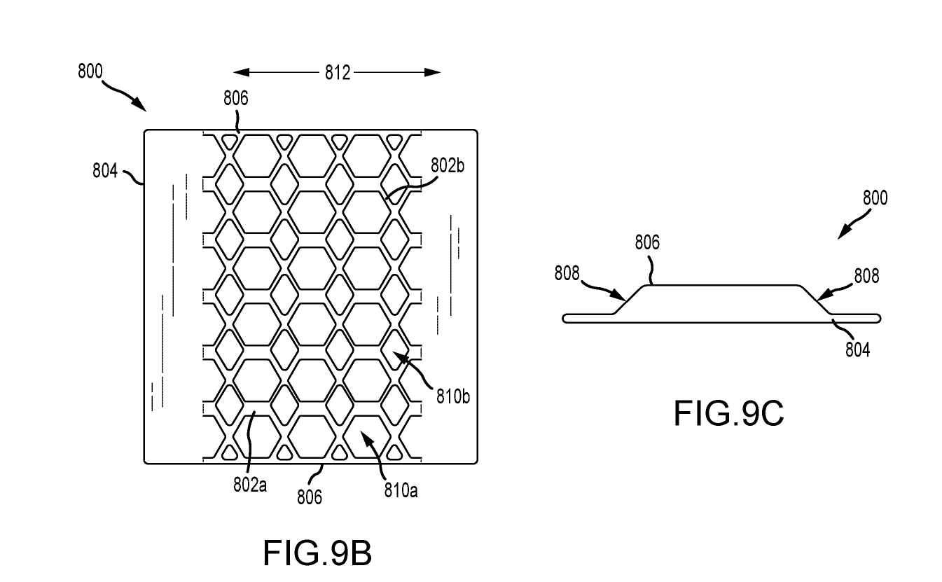

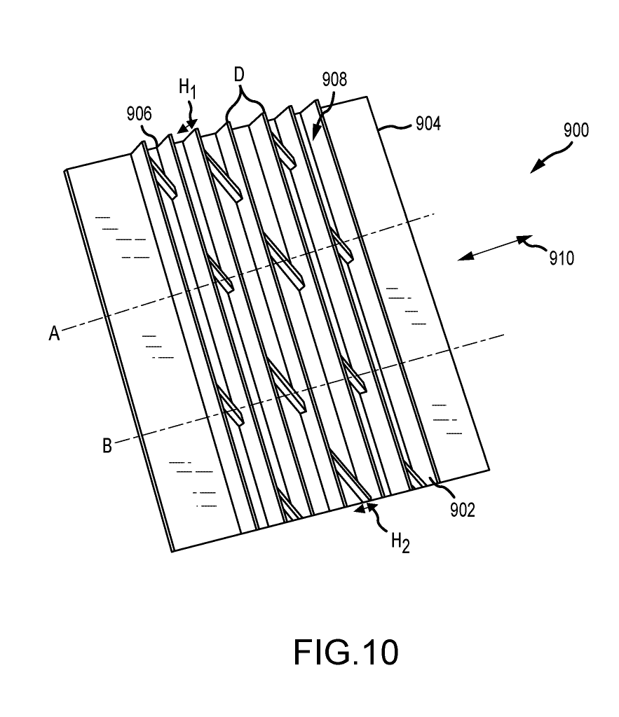

FIG. 9A is a perspective view of another corner pad 800. FIG. 9B is a front view of the corner pad 800. FIG. 9C is an end view of the corner pad 800. Referring concurrently to FIGS. 9A-9C, the corner pad 800 includes a plurality of fins 802 (also known as wands) shaped in a honeycomb-type pattern and joined by a continuous backer 804. The fins 802 extend substantially orthogonally from the backer 804 and between perimeter walls 806. Unlike the wedge shaped corner pads described above, which requires specific orientation when secured within the door frame, the corner pad 800 in this example is symmetrical about its longitudinal axis A_{L} as shown in FIG. 9A. The corner pad 800 is substantially trapezoidal-shaped with tapered profiles 808 as shown in FIG. 9C. This enables the corner pad 800 to be easily installed on the door frame when compared to the wedge shaped corner pads and have the same performance no matter which direction the door swings. Additionally, the corner pad 800 may be installed with either end (e.g., the perimeter wall 806) facing upward.

The fins 802, the backer 804, and the perimeter walls 806 define a plurality of cavities 810. The cavities 810 provide a void within the corner pad 800 that enable the fins 802 to be deflected by the door as it is opened and closed and form a seal between the door frame and the door such that air, water, dust, and/or debris is reduced or prevented from penetrating through the seal. In this example, the cavities are substantially hexagonal 810a and diamond 810b in shape. The hexagonal cavities 810a are formed by two opposing fins 802a that are oriented substantially parallel to a door swing direction 812 and two pairs of opposing fins 802b that are angled in relation to the door swing direction 812. The diamond cavities 810b are formed by the two pairs of opposing fins 802b. In the example, the fins 802a are thicker than the fins 802b, however, in alternative examples each fin may have a substantially equal thickness.

In this example, the pattern of the diamond cavities 810b form a triangle shape adjacent to the perimeter wall 806. Additionally, the fins 802a that are parallel to the door swing direction 812 increase the compressive force of the corner pad 800 so as to form a tighter seal. In other examples, the fins 802 may be formed in any other geometric pattern as required or desired. In further examples, the connections between the fins 802 may include a slit to facilitate a more easy deflection into the cavities 810.

Also, on the rear side of the corner pad 800, the backer 804 may include an adhesive layer (not shown) so that the corner pad 800 may be secured to the door frame. In some examples, the adhesive layer is an acrylic transfer tape with a paper liner or equivalent. In other examples, the backer 804 may be mechanically fastened to the door frame by a nail, a staple, or the like. In yet other examples, the backer 804 may be arched slightly, which may aid in adhering the corner pad 800 to the door frame.

FIG. 10 is a perspective view of another corner pad 900. The corner pad 900 includes a plurality of fins 902 (also known as wands) that are spaced apart a distance D and joined by a continuous backer 904. A plurality of struts 906 are disposed between adjacent fins 902. In the depicted example, the struts 906 are staggered, e.g., along lines A and B, meaning that if a strut 906 is disposed between a first fin 902 and an adjacent second fin 902, there is no strut disposed along line A between the second fin 902 and an adjacent third fin 902. Rather, a strut 906 is disposed along line B between the second fin 902 and the adjacent third fin 902. In examples, struts 906 can be oriented at any angle, for example, angles between about 0° and about 85° relative to the fins 902. Angles closer to the extremes of this range may provide too much resistance of the fins 902 to deflection; as such, angles between about 25° to about 65° may be more desirable. In some examples, the struts 906 are disposed at a location distal from a terminal end of the fins 902. In other examples, the struts 906 may be disposed at a location that is adjacent the terminal end of the fins 902.

In the depicted corner pad 900, each fin extends a height H₁ from the backer 904. In other example, each fin 902 may have a different height H₁ than adjacent fins 902, such as described in the examples above. The struts 906 may have a height H2 from the backer 504 that is generally less than the height H₁ of the fins 902. This allows the fins 902 to more easily deform when acted upon by an external force (e.g., the door). In other examples, however, the strut 906 may have a height H2 the same as the height H₁ of the fins 902. The thickness of each fin 902 may vary as required or desired for a particular application. Additionally, the thickness of each strut 906 may be similarly varied. Examples having fins 902 and struts 906 of the same thicknesses are also contemplated.

The fins 902 and the backer 904 at least partially define a plurality of cavities 908. The cavities 908 provide a void within the corner pad 900 that enable the fins 902 to be deflected by the door as it is opened and closed. In operation, corner pad 900 is mounted in the door frame such that the cavities 908 are positioned on a front side of the corner pad 900 with the backer 904 defining the rear side. The fins 902 are oriented substantially vertically within the door frame. This positions the fins 902 substantially perpendicular to a swing direction 910 of the door. When the door opens and closes the fins 902 deflect into the corresponding cavity 908 and form a seal between the door frame and the door such that air, water, dust, and/or debris is reduced or prevented from penetrating through the seal. Additionally or alternatively, the struts 906 facilitate reducing or preventing the fins 902 from contacting one another during collapse.

Additionally, in the example, the distance D between each fin 902 enables the deflection of the fins 902 without contacting one another. In other examples, the fins 902 may deflect and at least partially contact one another without significant stacking or overlap between adjacent fins 902. In some examples, the distance D between each fin 902 may be substantially equal in the corner pad 900, while in other examples the distance D between each fin 902 may be different.

On the rear side of the corner pad 900, the backer 904 may include an adhesive layer (not shown) so that the corner pad 900 may be secured to the door frame. In some examples, the adhesive layer is an acrylic transfer tape with a paper liner or equivalent. In other examples, the backer 904 may be mechanically fastened to the door frame by a nail, a staple, or the like. In yet other examples, the backer 904 may be arched slightly, which may aid in adhering the corner pad 900 to the door frame.

The corner pads described above in FIGS. 6-10 may be manufactured in accordance with processes now known or developed in the future. The corner pad profiles may be unitarily molded and then cut and/or trimmed utilizing laser cutting processes, hot wire cutting processes, or other processes. The adhesive layer may then be coupled to the elastomer. The corner pad or portions thereof may be 3D printed (additively manufactured) with a modified Stratasys or similar printer. In one example, the corner pad may be molded with an elastomer based material having a hardness between and including Shore 40 A and Shore 60 A. This enables the fins to deflect while still maintaining the fin's resilience to form a seal against the door edge to restrict air, water, dust, and debris from passing though the corner pad. Additionally, the elastomer is inherently durable and is wear resistant so as to withstand the repetitive motion of the door open and closing. No skin, film, or resin coating is required with the elastomer material, unlike the foam materials described above, and thus, the manufacturing process is simplified and less costly because the elastomer is molded in a single piece. In some examples, the elastomer may include Teflon filler to reduce friction between the door and the corner pad and increase ease of use. It is appreciated that while the corner pads described above may be manufactured by a molding process, the corner pads may alternatively or additionally be extruded, sequentially extruded, and/or coextruded as required or desired.

In the figures above, exemplary examples are depicted having particular dimensions. These dimensions are but examples and corner pads having other dimensions are contemplated. As such, the backer and fins may have differing lengths, widths, and/or heights, as required or desired for a particular application. As noted above, the backer and fins may be manufactured from the same material. The backer may have a greater thickness than the fins so as to provide more rigidity to the corner pad, or may be a similar thickness (or even thinner, in certain applications). A fin may have a reach of about 0.25 inches to about 0.375 inches, although any reach is contemplated as required or desired to seal the gap in the door. Additionally, adhesives may be applied to different areas of the backers as described herein.

Any number of the features of the different examples described herein may be combined into one single example and alternate examples having fewer than or more than all of the features herein described are possible. It is to be understood that terminology employed herein is used for the purpose of describing particular examples only and is not intended to be limiting. It must be noted that, as used in this specification, the singular forms “a,” “an,” and “the” include plural referents unless the context clearly dictates otherwise.

While there have been described herein what are to be considered exemplary and preferred examples of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A corner pad comprising:
a backer comprising a first side and a second side, wherein the first side is configured to receive an adhesive; and
a plurality of wands extending from the second side, wherein each of the plurality of wands comprises a first end and a second end, wherein each of the plurality of wands is integral with the backer at the second end forming an interface, and wherein each interface is substantially parallel to one another.

2. The corner pad of claim 1, further comprising a coating disposed on at least a portion of each of the plurality of wands, wherein the coating comprises a coefficient of friction less than a coefficient of friction of at least one of the plurality of wands.

3. The corner pad of claim 2, wherein the coating is disposed at the first end of each of the plurality of wands.

4. The corner pad of claim 1, wherein the backer comprises at least one outer edge, and wherein each interface is substantially parallel to the at least one outer edge.

5. The corner pad of claim 1, wherein each of the plurality of wands are substantially orthogonal to the backer.

6. The corner pad of claim 5, wherein each of the plurality of wands are substantially parallel to one another.

7. The corner pad of claim 1, wherein each of the plurality of wands are disposed at an angle relative to the backer.

8. The corner pad of claim 7, wherein each of the plurality of wands are substantially parallel to one another.

9. The corner pad of claim 5, wherein a first wand of the plurality of wands is disposed at a first angle to the backer and a second wand of the plurality of wands is disposed at a second angle to the backer, and wherein the first angle is greater than the second angle.

10. The corner pad of claim 1, wherein the first end of each of the plurality of wands have a substantially equal height above the second side.

11. The corner pad of claim 1, further comprising the adhesive.

12. The corner pad of claim 11, wherein the adhesive is a contact adhesive.

13. The corner pad of claim 1, wherein the backer comprises a backer width and the plurality of wands are arranged along a wand portion width, and wherein the wand portion width is at least about 50% of the backer width.

14. The corner pad of claim 13, wherein the wand portion width is at least about two-thirds of the backer width.

15. The corner pad of claim 1, wherein the backer is formed from a material that has a different durometer than a material that the plurality of wands is formed by.

16. A corner pad comprising:
a backer;
a plurality of fins extending from the backer, the plurality of fins defining a plurality of cavities defined within the corner pad, wherein upon a portion of a door sliding across the corner pad, at least a portion of the plurality of fins deflect at least partially into the corresponding cavity of the plurality of cavities such that the engagement of the corner pad with the door generates a seal that restricts air and water from penetrating therethrough.

17. The corner pad of claim 16, further comprising one or more struts spanning at least two adjacent fins of the plurality of fins, wherein the one or more struts are disposed at an angle relative to the at least two adjacent fins.

18. The corner pad of claim 17, wherein the strut is disposed at a location distal from a terminal end of each of the plurality of fins.

19. A method of manufacturing a corner pad comprising:
delivering a first material to an extrusion die;
substantially simultaneously delivering a second material to the extrusion die, wherein the first material has a different durometer than the second material; and
coextruding the first material with the second material to form an extruded product, wherein the extruded product includes a backer formed by the first material and a plurality of wands extending from the backer formed by the second material, wherein each of the plurality of wands are integral with the backer forming an interface, and wherein each interface is substantially parallel to one another.

20. The method of claim 19, further comprising:
delivering a third material to the extrusion die substantially simultaneously with the first material and the second material; and
coextruding the third material such that the extruded product further includes a coating disposed on at least a portion of each of the plurality of wands.
